(19) United States
(12) Patent Application Publication
(10) Pub. No.: US 2003/0053055 A1
(43) Pub. Date: Mar. 20, 2003

(54) Methods, apparatus, computer program products, and systems for lens alignment and fabrication of optical signal controllers

(76) Inventors: Bulang Li, Fremont, CA (US); Navrit Singh, Fremont, CA (US)

Correspondence Address: LARRY WILLIAMS, 122 CALISTOGA ROAD, PMB-301, SANTA ROSA, CA, 95409-3702, US

(21) Appl. No.: 10/179,470

(22) Filed: Jun. 24, 2002

Related U.S. Application Data
(60) Provisional application No. 60/300,536, filed on Jun. 22, 2001.
(60) Provisional application No. 60/300,517, filed on Jun. 22, 2001.

(51) Int. Cl. G01B 11/00

(52) U.S. Cl. 356/399

(57) ABSTRACT

Methods and apparatus are provided for manufacturing optical signal controllers such as optical switches. The methods and apparatus can be used for aligning optical elements such as output lens for the optical signal controller. The methods and apparatus may allow substantially automated alignment of optical components in the optical signal controller.

### CROSS-REFERENCE

The present application claims benefit of U.S. Provisional Patent Application No. 60/300,536, filed on Jun. 22, 2001 and U.S. Provisional Patent Application No. 60/300,517, filed on Jun. 22, 2001. The present application is related to U.S. Provisional Patent Application No. 60/300,536, filed on Jun. 22, 2001, U.S. Provisional Patent Application No. 60/300,517, filed on Jun. 22, 2001, and U.S. Provisional Patent Application No. 60/256,059, filed on Dec. 15, 2000. All of these applications are incorporated herein, in their entirety, by this reference.

### BACKGROUND

This invention relates to improved methods, apparatus, and systems for output lens alignment for fabricating optical signal controllers such as optical switches, variable optical attenuators, and optoelectronic switches.

Optical switches and interconnects are relatively new devices used primarily in the communications industry. They are primarily used for optical networks and for optical network testing and measurements. This technology is currently in its infancy, and new applications are being developed rapidly.

U.S. Provisional Patent Application No. 60/256,059, filed on Dec. 15, 2000, describes an optical switch that includes high speed, high precision motors such as voice coil motors to carry out optical switching for applications such as optical signal based communication systems. This configuration is expected to have a switch time delay. per channel that is significantly shorter than that for standard optical switch technology. Some embodiments of the invention described in Application No. 60/256,059 are expected to have switch time delays that may be about a factor of 10 (or more) shorter than that for the standard optical switch technology. U.S. Provisional Patent Application No. 60/256,059, filed on Dec. 15, 2000 is incorporated herein, in its entirety, by this reference.

Optical switches such as those described in Application No. 60/256,059 require alignment of the optical components involved in the switching operation. Specifically, the aligning of optical components such as the gradient refractive index lens is a critical part of the optical switch manufacturing process. The standard methods for optical alignment are time-consuming and difficult because of the level of precision that is acquired. Indeed, the alignment process can significantly increase the cost of manufacturing optical switches. In addition, new switch technologies such as those described in Application No. 60/256,059 that use rotary switching operations make the standard alignment process even more problematic.

There is a need for reliable and efficient methods and apparatus for optically aligning lenses in optical signal controllers such asoptical switches. Furthermore, there is a need for complete systems capable of allowing rapid alignment of rotary optical signal controllers. In addition, there is a need for optical signal controllers that have greater reliability and increased capabilities for long-term reliable operation.

### SUMMARY

This invention is related to optical and optoelectronic systems that use optical signal controllers such as those used for communication, information processing, and information transfer. More specifically, the invention is related to methods, apparatus, systems, and computer program products for optical component alignment in optical signal controllers such as optical switches, methods of manufacturing optical signal controllers, a station for manufacturing optical signal controllers, and optical signal controllers. It is to be understood that optical signal controllers may also include a power monitor, a fiber collimator, an optical isolator, and an optical circulator.

An aspect of the invention includes methods of aligning lenses in optical signal controllers such as aligning gradient refractive index (GRIN) lens in optical switches. Another aspect of the present invention includes apparatus for aligning optical elements such as lenses. Another aspect of the present invention includes software and computer program products for aligning optical elements such as gradient refractive index lenses. Still, another aspect of the present invention includes optical signal controllers having optical elements that have been aligned using methods according to the present invention.

It is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out aspects of the present invention. It is important, therefore, that the claims be regarded as including such equivalent constructions insofar as they do not depart from the spirit and scope of the present invention.

The above and still further features and advantages of the present invention will become apparent upon consideration of the following detailed descriptions of specific embodiments thereof, especially when taken in conjunction with the accompanying drawings.

### DESCRIPTION OF THE DRAWINGS

FIG. 1 is a diagram of an embodiment of the present invention.

FIG. 2 is a diagram of components illustrated in the embodiment of the present invention shown in FIG. 1.

FIG. 3 is a diagram of an embodiment of the present invention.

FIG. 4 is a diagram of an embodiment of the present invention.

FIG. 5 is a schematic diagram of an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

This invention pertains to methods, apparatus, systems, and computer program products for optical component alignment in optical switches, optical switch manufacturing processes, and optical switches. The present invention now will be described more fully hereinafter with reference to the accompanying drawing, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In one embodiment, the apparatus includes an optical component capable of projecting an optical signal and capable of receiving a reflected optical signal, one or more output lenses, and a driver such as a voice coil motor. The voice coil motor is coupled to the optical component so that movement of the voice coil motor can be used to actively adjust the direction of optical signal projection from the input optical component. The lenses are disposed so as to receive optical signals projected from the optical component; each lens is associated with an optical channel. Preferably, in completed optical signal controllers, the lenses are coupled to other optical components so as to allow continuing the propagation of the optical signal or otherwise processing the optical signal.

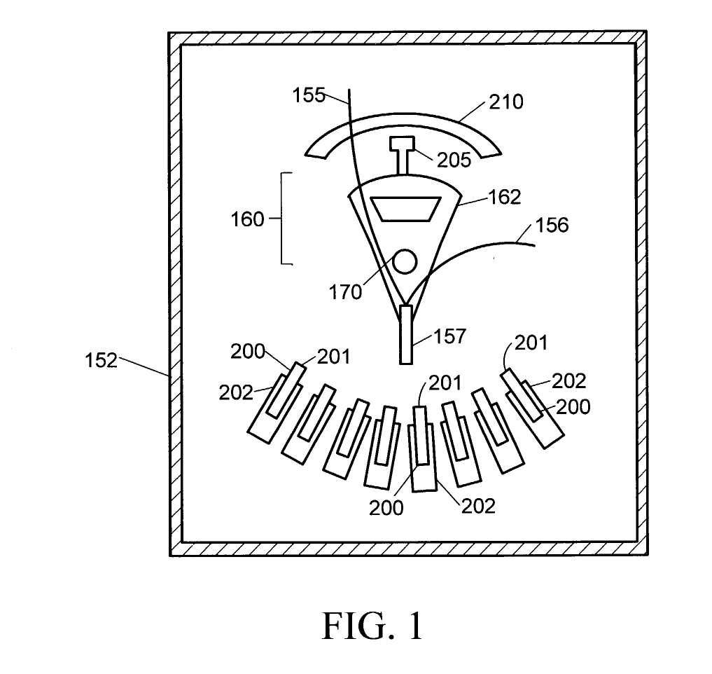

Reference is now made to FIG. 1 wherein there is shown a diagram of an optical switch wherein the optical components, specifically, at least one output gradient refractive index (GRIN) lens, are aligned according to an embodiment of the present invention. The optical switch includes a housing 152, an input optical fiber 155, a reflected signal optical fiber 156, and a collimator 157, a voice coil motor 160, a pivot bearing 170, and at least one, preferably a plurality, of output gradient refractive index lens 200 corresponding to output optical signal channels. Lens 200 includes a semi reflective face 201 having a predetermined reflectivity for an aligned incident light beam.

The embodiment shown in FIG. 1 also includes a lens support 202 for holding lens 200. Lens support 202, optionally, maybe an integral part of housing 152. In other words, support 202 may be a surface of housing 152. Alternatively, support 202 may be a discrete structure connected with housing 152 so as to hold GRIN lens 200 substantially within housing 152. Preferably, support 202 is a substantially rigid structure capable of holding lens 200.

FIG. 1 shows housing 152 in cross-section; specifically, the top section of housing 152 has been removed to provide a top view of the interior of housing 152. Housing 152 substantially contains voice coil motor 160. Voice coil motor 160 includes coil 162 and permanent magnets (the permanent magnets are not shown in FIG. 1) set in a standard arrangement for a rotary motion voice coil motor similar to that commonly used in disk drives. It is to be understood that the fundamental operation of voice coil motors is a well-understood technology. As such, the details of voice coil motor technology are not repeated in this description. However, the information is readily available in the technical literature and published patents. For example, see U.S. Pat. No. 5,329,412, incorporated herein by this reference.

Voice coil motor 160 is rotatably coupled to pivot bearing 170 to allow rotary motion about pivot bearing 170. Pivot bearing 170 is supported by housing 152. Input optical fiber 155 and reflected signal fiber 156 are coupled with collimator 157 forming a dual fiber collimator. The collimator 157 is connected with voice coil motor 160 so that rotary motion of voice coil motor 160 causes collimator 157 to move so as to change the direction of optical signal propagation or optical signal reception for collimator 157. Preferably, a controller (not shown in FIG. 1) provides the control signals for voice coil motor 160. Input optical fiber 155 is arranged to project optical signals toward lens 200 so that lens 200 receives the optical signals.

In preferred embodiments, the reflective face 201 of lens 200 comprises a semi-reflective coating applied to lens 200 so as to reflect a predetermined percentage of an aligned incident light beam such as that which occurs when the lens is properly aligned with respect to optical signals from collimator 157 and optical fiber 155. Consequently, and measurements of the reflected signal can be used as a control signal for optical alignment between lens 200 and collimator 157. In other words, embodiments of the present invention use the measurements of the reflected signal as a control signal for closed loop process control of the alignment process.

During the alignment process, input optical fiber 155 is coupled to a laser light source for providing the input optical signal. In addition, fiber 156 is coupled to an optical signal detector capable of measuring optical signal intensity of the reflected optical signal. The reflected optical signal from the semi reflective face 200 is directed back toward collimator 157. The collimator 157 receives the reflected signal and transmits the reflected signal to the reflected signal optical fiber 156.

FIG. 1 also shows an optional position indicator for electronically monitoring the position of the voice coil motor. Those of ordinary skill in the art will recognize that a wide variety of hardware configurations can be used to perform as the position indicator. The embodiment shown in FIG. 1 includes a photosensor 205 connected with coil 162 of voice coil motor 160 so that photosensor 205 moves with coil 162. An array of LEDs 210 is arranged near photosensor 200 so that photosensor 205 can derive position information by detecting the LEDs in array of LEDs 210. Of course, in an alternative embodiment, a movable photodiode may be used and an array of photo detectors can be used.

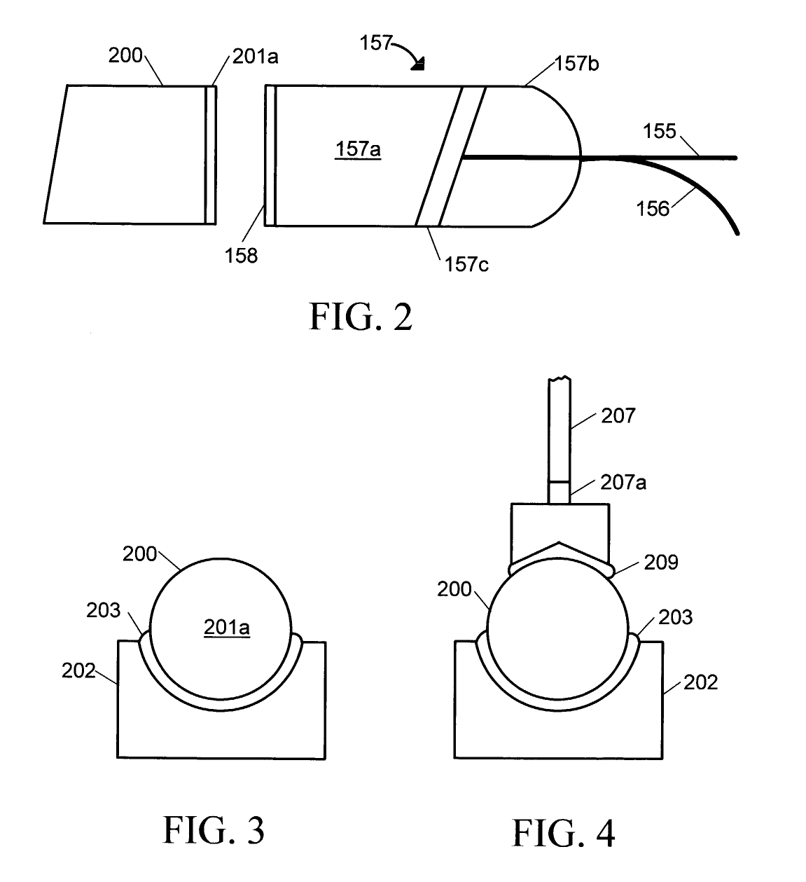

Reference is now made to FIG. 2 wherein additional details of the switch in FIG. 1 are shown. Collimator 157 is a dual fiber collimator as stated supra. Input optical fiber 155 and reflected signal optical fiber 156 are coupled to collimator 157. Collimator 157 includes a gradient refractive index lens 157a and an optical fiber ferrule 157b for holding the ends of fiber 155 and fiber 156. Ferrule 157b can hold the ends of optical fiber 155 and fiber 156 in place. In this embodiment, the ends of fiber 155 and fiber 156 substantially face the same direction. Optionally, an attaching material, such as epoxy 157c, couples lens 157a and ferrule 157b together. In preferred embodiments of the present invention, an antireflection coating 158 is applied to the output surface of collimator 157 that receives the reflected signal.

The use of collimators with optical fibers is well known to those skilled in the art; there are numerous possible configurations and the example given here is not to be interpreted as a limitation for embodiments of the present invention. As an example alternative, GRIN lenses 157a may be held in place by fittings and epoxy 157c may be replaced by an air gap.

FIG. 2 shows lens 200 contacting semi-reflective film 201 a. A gap such as an air gap lies between films 201a and 158. The size of the air gap typically depends on the size of the fittings and amount of the signal to be reflected back to fiber 156. Typically, the air gap may be in a range of approximately 100 microns to 5 millimeters. A smaller air gap typically gives better performance. However, enough space should be allotted for movement of parts within the housing 152 without film 201a and film 158 contacting each other.

Attention is now directed to films 201a and 158 and the operation of the optical configuration shown in FIG. 2. An optical signal at a first light intensity is transmitted through optical fiber 155 to lens 200. A small portion of the optical signal is reflected by semi-reflective film 201a back to optical fiber 156. Films 201a and 158 typically have a composition different from their adjacent GRIN lenses 200 and 157a, respectively. Films 201a and 158 are typically an oxide, a nitride, or a combination thereof. Some examples of the materials for films 201a and 158 include silicon nitride, titanium dioxide, tantalum nitride, other refractory metal oxides or nitrides, combinations thereof, or the like. Films 201 a and 158 may have compositions that are the same or different from each other.

The amount or lack of reflection by films 201 a and 158 can be adjusted by controlling the thickness of films 201 a and 158. The thickness of film 158 should be selected to minimize reflection. In other words, reflection should be as close to zero as reasonably possible. The thickness of film 201a should be selected to allow a relatively small fraction of light to be reflected. Typically, the amount of reflection of the light from optical fiber 155 should be in a range of approximately 0.2 to 5.0 percent and more commonly in a range of approximately 0.5 to 1.5 percent. Ideally, the amount of reflection may be approximately 1.0 percent. By knowing the composition of the films 201a and 158, the wavelength of the light, and the amount of light, if any, to be reflected, skilled artisans may use conventional method(s) to determine the thicknesses of films 201a and 158.

The use of GRIN lenses 200 and 157a is not required. Other optically transparent objects may be used. The surfaces of the other optically transparent objects near films 201a and 158 should be substantially flat. In this manner, each of films 201a and 158 can be substantially flat, uniformly thick.

When optical alignment is achieved for grin lens 200 and collimator 157, the surface of films 201 a and 158 may be approximately perpendicular to the lengths of fibers 155 and 156 within collimator 157 and to the light paths using the optical configuration shown in FIG. 2. In a preferred embodiment, films 201a and 158 are not perpendicular to the incident and reflected light path, but at an angle of 88.2 degrees for accommodating a spatial separation of 125 microns between the optical fiber 155 and the reflected signal fiber 156, meanwhile reducing the etalon effect induced by having surfaces 201a and 158 parallel. The optical configuration of FIG. 2 may allow up to 99% of the intensity of the optical signal from optical fiber 155 to be transmitted to lens 200. Reflected light may enter reflected signal fiber 156.

Reference is now made to FIG. 3 wherein there is shown a more detailed diagram of a portion of the embodiment shown in FIG. 1. Specifically, FIG. 3 shows an optional embodiment for bonding grin lens 200 to housing 152. FIG. 3 shows lens 200 and lens support 202. Lens support 202 is connected with housing 152 (housing 152 not shown in FIG. 3). Support 202 includes a recessed area in which at least a portion of lens 200 fits therein. The hidden upper edge of support 202 is shown with broken lines. The recessed area is an option and other configurations may be used that may not include a recessed area. An attaching material 203 is shown contacting lens 200 and support 202; attaching material 203 is provided to form a substantially fixed attachment of lens 200 to support 202. FIG. 3 shows a view facing film 201 a. An attaching material such as epoxy 203 is shown contacting lens 200 and lens support 202. In other words, epoxy 203 attaches lens 200 to lens support 202 so that when epoxy 203 is cured, lens 200 has a substantially rigid bond with housing 152 through lens support 202. It is to be understood that attaching materials other than epoxy may be used for bonding lens 200 to support structure 202; as an example, a solder may be used for bonding lens 200 to lens support 202.

FIG. 4 illustrates a method of holding lens 200 in contact with epoxy 203 prior to curing the epoxy. A holder 207 is shown attached to a lens gripper 208 using a clamping mechanism by holder 207. Lens gripper 208 is shown attached to lens 200 with epoxy 209. Epoxy 209 is chosen to be a weaker epoxy with regards to its tensile strength than epoxy 203, therefore, gripper 208 can be easily removed from lens 200 after optical alignment and without affecting the relative position between lens 200 and support 202. Holder 207 may be part of a motion actuator for adjusting the position of lens 200 during alignment. Preferably, holder 207 includes a clamping mechanism 207a for connecting holder 207 with gripper 208. Preferably, holder 207 comprises a substantially rigid elongated member such as a member made of a material such as metal, ceramic, glass, and quartz.

During the alignment of lens 200, holder 207 holds lens 200 with epoxy 209 so that the lens 200 is moved to the aligned position through motions of holder 207. Lens 200 is bonded to lens support 202 when alignment is achieved. After lens 200 is bonded to support 202, lens 200 is detached from holder 207 by breaking the attachment of epoxy 209.

Another embodiment of the present invention includes a method of aligning lenses in an optical signal controller such as an optical switch. A more specific embodiment includes a method of aligning a gradient refractive index lens of a rotary motion optical switch having n output channels. The lens includes a surface having a predetermined optical reflectivity, and the lens is disposed proximate to an output channel of the switch. The switch includes a base, a dual fiber input collimator including an input signal fiber and a reflected signal fiber. The collimator is rotatably connected with the base, and the base includes a surface for attaching the lens. The method includes the step of directing a laser beam toward the lens reflective surface using the input optical fiber and the collimator and measuring reflected light from the lens reflective surface via the collimator and reflected signal fiber. The method further includes a step of moving the position of the lens reflective surface with respect to the light of the laser beam until the amount of light reflected by the lens reflective surface substantially equals a predetermined amount that corresponds to alignment of the lens with respect to the laser beam. As an option, once the position of the grin lens is optimized, the value of the reflection may be displayed and recorded as a reflected signal level of the channel. In other words, the measured reflection may be used as a figure of merit for the performance of the switch for that particular channel. The next step includes bonding the lens to the optical signal controller so as to maintain the amount of measured reflected light.

After completing the alignment of the lens for the first channel, the method includes the step of rotating at least one of the collimator and the base so as to direct the laser beam toward a second channel and a second lens. The second lens is aligned using steps analogous to those for the previous lens. After aligning the second lens, the method includes the step of bonding the second lens to the optical switch. The method steps are repeated for each remaining channel until a lens has been aligned and bonded for each channel of the optical switch.

A further embodiment of the method includes the step of producing at least one of pitch motion, yaw motion, and pitch motion and yaw motion of the lens when aligning the lens. Of course the method may also include x, y, and z, motion of the lens for some situations. However, high sensitivity alignment will primarily be achieved through producing pitch motion, yaw motion, and combinations thereof. The pitch and yaw motions can be implemented as an iterative process to maximize the reflection or other measure of optical alignment. The movement can be controlled using a controller such as a computer, a microprocessor, and other type of electronic device. In one embodiment, an error signal is generated based on the measured reflected light intensity. An example of a suitable error signal would be the expected reflectivity at alignment and the measured reflectivity; in other words, the predetermined reflectivity of the reflective face of the lens minus the measured reflectivity. The error signal is generated in real time to create a feedback signal for the pitch and yaw adjustment motion.

A variety of techniques may be used for bonding the lens to the switch. Embodiments of the present invention may use bonding methods such as bonding with at least one of ultraviolet light cured epoxy, heat cured epoxy, low-temperature soldering, laser welding, and combinations thereof. A preferred embodiment of the method includes the step of bonding the lens to the switch using ultraviolet light cured epoxy.

In a preferred embodiment of the present invention, the step of moving the lens includes using a micro-motion actuator for producing small changes in the position and orientation of the lens with respect to the laser beam. Suitable micro-motion actuators are commercially available. More preferably, the step involves using the micro-motion actuator for producing at least one of pitch motion, yaw motion, and pitch motion and yaw motion of the lens with respect to the laser beam.

Optionally, the method further includes the step of recording the reflected light measurements as a function of the movement of the lens so as to derive sensitivity curves relating reflected light signals and movement of the lens. In preferred embodiments, the reflectivity measurements are recorded as a function of pitch movement, yaw movement, and pitch and yaw movement of the lens during the alignment. These plots of the experimental data can serve as Lens Alignment Sensitivity Plots (experimental curves) that can be used as part of the alignment process. Optionally, the method includes storing the measurements electronically. Alternatively, the measurements may be printed out in a hardcopy format.

After completion of the alignment of each of the lenses, the method includes further optional steps of testing and documenting the performance of the optical switch. The method may further include the step of performing a scan of all of the channels in the switch and measuring the reflected optical signal for each of the aligned lenses. Currently, the scan is done with very high arc resolution relating reflectivity and position at which the measurements are taken. The data of the scan may be automatically collected, tabulated, and stored electronically such as on a hard disk, floppy disk, or other electronic information storage media.

The method may further included the step of plotting reflected power measurements and input power as functions of position information for the input collimator. In some embodiments, the method optionally includes the steps of calculating the channel-to-channel spacing using the recorded data; also, each channel's maximum reflected power may be derived using the data.

A preferred embodiment includes the optional step of making all of the data available to the computer program containing the main code for aligning the lenses. Specifically, all of the position and power measurements data can be incorporated into a code file for each particular switch and made available so that it can be downloaded to an electronics control board of the switch. In other words, some embodiments of the switch are capable of storing computer program; the code file for each switch can be stored in the memory resources of the switch.

A further embodiment of the present invention may include the optional step of generating barcode indicia such as on a physical bar code label and associating the barcode indicia with a code file for a switch so that the code file can be identified using the barcode indicia. The barcode indicia, preferably, is applied to the housing of the switch so that the barcode indicia is easily available. This can be accomplished by simply applying a barcode label having the indicia adhesively to the housing of the switch.

Optionally, the method may include further steps of testing the switch. For example, the method may include the step of loading the code to the internal controller for the switch and allowing the internal controller to perform the switch in functions while recording the reflected light signals and transmitted light signals as functions of the collimator position. The data recorded with the switch under internal control is compared to the data recorded previously. In the internal control data substantially corresponds to that of the previous data, in other words, meets the specifications, then the switch is sent to the next fabrication step. If the specifications are not met, then the process is repeated starting with the step of scanning all of the channels under the control of the alignment station.

Another optional step of the method includes providing a hard copy of the data file of position versus power reflection curve and sending the hardcopy along with the switch to the next fabrication station.

In a preferred embodiment of the method, the step of moving the lens to achieve alignment is carried out with the lens contacting an unset or uncured attaching material that is also contacting a lens support surface of the switch. An advantage of the step is that the lens can be bonded using the attaching material by curing or allowing the attaching material to set without having to apply the attaching material after the alignment position for the lens has been found. Consequently, there is reduced opportunity for disturbing the alignment that can occur if the attaching material is applied after the alignment is obtained. An example of suitable materials for the attaching material includes uncured epoxy compounds such as ultraviolet light cured epoxy and heat-cured epoxy. For specific embodiments, an amount of un-cured epoxy is applied to the lens-contacting surface of the switch followed by contacting the lens to the epoxy.

Embodiments of the present invention include a Grin-Lens Assembly Station that can automatically align gradient reflective index lenses to an input collimator of an optical signal controller so as to achieve a desired or maximum reflective coupling. The assembly operation includes aligning a gradient refracted index lens having a semi reflected face such as, for example, a 1%-reflective face with respect to incoming collimator beam from the input collimator to maximize light reflection to one of two optical fibers that make up a dual-fiber ferrule of the input collimator. In the alignment station, the dual-fiber collimator is used to project light into the lens being aligned. The position of the lens is adjusted using pitch and yaw direction movements relative to the incoming beam until the reflected light (1% of incoming for this example) is focused and maximized on the reflective signal measuring fiber that is one of the fibers of the dual-fiber ferrule of the input collimator.

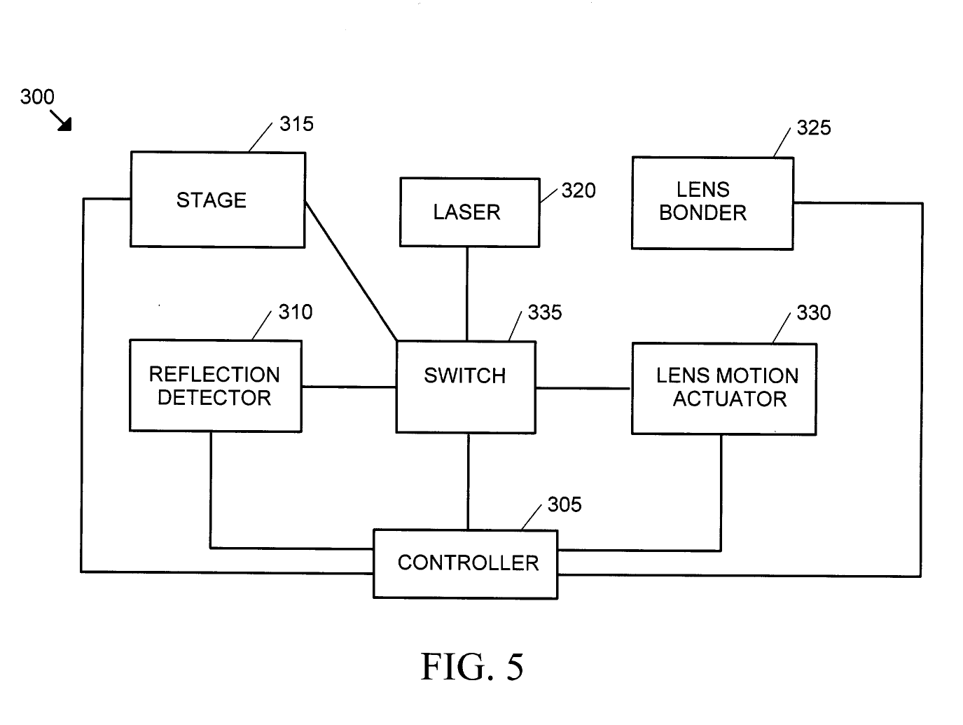

Reference is now made to FIG. 5 wherein there is shown a schematic diagram of a lens alignment station 300 according to one embodiment of the present invention. The station includes a station controller 305 such as, for examples, a computer, a microprocessor, and an application specific integrated circuit. Preferably, the controller is a main computer capable of sending and receiving information. In one configuration, the computer transfers information using a bus such as a general-purpose interface bus. Station 300 also includes a light intensity measuring device such as reflection detector 310, a stage 315, an optical signal source such as a laser 320, a lens bonder 325, and a lens motion actuator 330. Controller 305 is connected with the detector 310, stage 315, lens bonder 325, and lens motion actuator 330 so that information and/or control commands can be transferred between controller 305 and the connected items. Optionally, controller 305 may also be connected with laser 320 so that information and/or commands can be transferred between controller 305 and laser 320.

FIG. 5 also shows how a switch such as a rotary switch 335 would be arranged when being processed by station 300. More specifically, FIG. 5 shows how switch 335 would be connected with the elements of station 300 while station 300 is performing an alignment on switch 335. For this example, switch 335 is substantially the same as that described for the switch in FIG. 1.

As indicated in FIG. 5, optical switch 335 is electronically coupled to controller 305 so that controller 305 and optical switch 335 can interchange commands and information. In some embodiments, controller 305 is connected to switch 335 to allow controller 305 to control the movement of the voice coil motor in switch 335. Optionally, switch 335 and controller 305 may be connected so as to allow data collected by controller 305 to be downloaded to switch 335 and stored in memory resources that may be available in switch 335.

Reflection detector 310 is capable of measuring the intensity of a reflected laser beam. Particularly, particularly detector 310 is for measuring the reflected optical signal from the semi reflective surface of a lens that is being aligned in station 300. There are numerous commercially available detectors that are suitable for use as detector 310. The detector 310 is capable of transmitting reflected signal measurement data to controller 305. During the alignment process reflection detector 310 is connected with switch 335 so as to measure the reflected optical signal used for aligning the lens.

Stage 315 is preferably a rotary stage for supporting and holding switch 335 during the lens alignment. In preferred embodiments, stage 315 is capable of clamping a switch such as switch 335 in place so that rotary motion produced by the stage causes rotation of the switch. Preferably, the rotation caused by stage 315 is coaxial with the rotation of the input collimator of the switch. Stage 315 also includes a holder for substantially locking the movement of the input collimator of the switch so that the collimator points in a predetermined direction. In one embodiment the holder comprises a substantially rigid structure connected with the stage that makes contact with the collimator so as to prevent motion of the collimator. It is to be understood that this is but one embodiment of the present invention; a person of ordinary skill in the art will understand that other methods can be used for locking the position of the collimator during the alignment. For example, the collimator position may be locked in place, in part, through use of the voice coil motor used for controlling the motion of the collimator. Still further, power may be applied to the voice coil motor so that the voice coil motor actively pushes against the holder to so as to lock the collimator in place.

Stage 315 is arranged so that it can receive and perform control commands from controller 305. In some embodiments, stage 315 includes one or more motorized drives controlled by controller 305. Examples of commands from controller 305 include commands to stage f315 to cause stage f315 to rotate switch 335 so that a subsequent channel can be positioned for lens alignment.

A variety of lasers are commercially available that can be used for laser 320. Suitable lasers are commonly used for optical signal transmission testing. In preferred embodiments, laser 320 is capable of being connected with controller 305 so that laser 320 can transfer information to controller 305. As a further option, laser 320 may be arranged so that controller 305 can cause laser 320 to perform actions such as turn on, turn off, initialized, and follow other commands. During the alignment, a laser beam output from laser 320 is connected with switch 335 so as to provide the input laser beam as described earlier.

Lens bonder 325 may be selected from a variety of technologies for bonding a lens to an optical switch. For example, lens bonder 325 may include an ultraviolet light source used for curing ultraviolet light sensitive epoxy. In this case, the ultraviolet light source would be directed to impinge upon the epoxy used for attaching the lens to the switch. Alternatively, lens bonder 325 may include a heat source used for curing thermal setting epoxy. As another alternative, lens bonder 325 may include a laser for laser welding the lens to the switch. As still another alternative, lens bonder 325 may include a mechanism for soldering the lens to the switch. Lens bonder 325 is disposed with respect to the switch so as to allow the bonding step to be performed. Lens bonder 325 is connected with controller 305 so that controller 305 can initiate and terminate the bonding step as needed when the aligned position of the lens has been found.

Lens motion actuator 330 is connected with the lens during the alignment of the lens. The actuator 330 is capable of holding the lens proximate to a channel of the switch for which the lens is being aligned. For some embodiments of the present invention, this may include holding the lens in contact with an uncured attaching compound on the switch. Preferably, actuator 330 includes a miniaturized mechanical mechanism for holding the grin lens in front of the input beam and pitch/yaw the lens to optimize light reflection.

Preferably, the mechanism holds the lens proximate to the location for bonding such as a recessed area of a lens support or an output post slot for the channel. The mechanism has micro-maneuvering capabilities in the pitch and yaw directions. In one embodiment, the mechanism is controlled by three linear-translation-mechanical mechanisms or piezo-electric crystals. The combination of three translation motions on a spherical surface allows generation of highly precise and repeatable pitch and yaw adjustment motion at the virtual center of the spherical surface which coincides with the front surface center of the grin lens. The mechanism may be operated under the command of computer 305, the magnitude and the direction of the pitch and yaw motion is decided by the feedback signal generated from the reflected light measurements which may be used in the form of a light reflective coupling ratio. Actuators suitable for use in embodiments of the present invention are commonly used and are commercially available from vendors such as Physik Instruments GmbH & Co and Suruga Seiki Co. Ltd. Preferably, actuator 330 is capable of producing micro-scale motions of pitch, yaw, and combinations thereof.

In preferred embodiments, actuator 330 is connected with controller 305 so that controller 305 can provide feedback control commands for adjusting the movement of the lens in response to an error signal produced using measurements from detector 310 of the reflected light signal. Upon detection of alignment, based on the error signal, controller 305 stops the motion of actuator 330 and initiates the lens bonding by sending a command to bonder 325.

As an option for some embodiments of the present invention, station 300 also includes a bar code printer (not shown in FIG. 5) connected with controller 305. The bar-code printer may be used for printing labels with bar-code indicia for identifying measurement data for each aligned switch. In an alternative embodiment of the present invention, stage 315 may be replaced with a fixed stage and a radial arc positioning mechanism, such as a MicroE PA155 encoded actuator made by MicroE Systems, Inc., Natick, Mass. The MicroE PA155 is arranged upside down with the center of the shaft aligned with the center of the arm of the switch as a part of station 300. A driving arm with orthogonal pin may be attached to the MicroE rotary shaft to hold the switch collimator and to move the collimator radially in front of the output channels. The radial arc mechanism can be fully configured by using a motion control board interfaced with controller 305 so that substantially all theoretical radial center positions of each channel of the output post are available. The radial arc mechanism is capable of going to the center of any channel and performing a high resolution seek to optimize reflection of the channel; this mechanism can be used to work in conjunction with the pitch-yaw mechanism of actuator 330 to optimize the reflected power signal.

Optionally, station 300 may also include a base (not shown in FIG. 5) for supporting stage 315 and actuator 330. The base may also be used to support lens bonder 325. Preferably, the base provides a substantially stable surface with reduced vibration susceptibility. A suitable base may include a high-density material such as a mass of granite; granite is also advantageous because it has superior dimensional stability properties.

In addition, embodiments of station 300 may also include a table or a frame for holding the components of the station. In a still further embodiment of the present invention, station 300 may also include wheels or casters for rolling the station when the station needs to be moved.

Another embodiment of the present invention includes computer executable instructions for performing the alignment of lenses in an optical signal controller.

These instructions may reside in a computer, a microprocessor, an application-specific integrated circuit, or computer readable media such as compact disks, and floppy disks.

Embodiments of the present invention may include computer executable instructions for performing the steps of:

a) placing a lens proximate to a first output channel position of an optical signal controller;

b) controlling the movement of the lens with respect to a laser beam directed toward the lens so as to achieve a measured amount of reflected light from the lens that substantially equals to a predetermined amount of light;

c) activating a bonding process so as to bond the lens to the signal controller when the measured amount of reflected light equals a predetermined amount of light;

d) repeating steps a through c for each channel of the optical signal controller.

Embodiments of the present invention may further include instructions for recording measurements of the amount of light reflected by the lens as a function of the movement of the lens and for recording the reflected light intensity as a function of input collimator position. A preferred embodiment of the present invention also includes instructions for at least one of rotating the direction of the laser beam and rotating the optical signal controller.

Preferably, data collection, data storage, motion control of the optical switch, alignment optimization algorithm, user interface, function display, and data display can be arranged under the control of controller 305. The control theory for the alignment algorithm can be written in C++ and executed in interpreted fashion for fast execution in a real time working environment of the switch. It is to be understood that the algorithm can be written, as an option, in other computer programming languages such as C, BASIC, assembly language, and others.

Design for manufacturability is, essentially, inherent for embodiments of the present invention. Aspects of the present invention are usable in a rotary motion switch such as that described for FIG. 1 and such as the radial/rotary switch described in U.S. patent application No. 60/256,059, filed on Dec. 15, 2000.

One of the benefits of embodiments of the present invention is that each channel of the optical signal controller is aligned using the same alignment algorithm, the same gripping mechanism, and the same software and computer code. This means that each channel can be aligned within about the same alignment time. Reproducibility is maximized; the same alignment station can be used to align similar optical signal controllers.

It is to be understood that the embodiment of the present invention shown in FIG. 1 is but one configuration. In alternative configurations, optical components other than optical fibers may be included or may replace the optical fibers described for the embodiment shown in FIG. 1. Some examples of the types of optical components are optical fibers, prisms, mirrors, electronic detectors such to as photo-detectors, and lasers.

Embodiments of the present invention can be used to accelerate fabrication of optical signal controllers that include optically aligned output lenses. An example of an estimated time budget for aligning output lenses in an optical signal controller according to one embodiment of the present invention will now be provided. The estimate is for an 8-channel optical signal controller such as a 1×8 channel optical switch having one input collimator and 8 output channels.

1. Loading switch into alignment station and optical and electrical hook up (2 min).

2. Boot up the computer system and download the software for aligning a 1×8 switch (2 min).

3. Start alignment-computer program (1 min).

4. System reference check and initialization of alignment station components and mechanisms (2 min).

5. Align lens for channel one and bond lens to switch with UV curable epoxy and application of UV light (max 3 min).

6. Move to each of the remaining channels, aligning the lens and bonding the lens to the switch at each channel (max: 7×3 min=21 min).

7. Data collection and curve plotting and data storage and data analysis (parallel processing) (0 min).

8. Final scan of all the channels (1×8) 12 seconds per channel (2 min).

9. Bar code read, data transfer to code computer and download of firmware code to switch (1 min).

10.Voice coil motor sweep of channels (2 min).

11. Update code (1 min).

12. Unload switch from alignment station, hardcopy data print, and update records (5 min).

Total approximate time is around 40 min per 1×8 switch with a fully automated station; in other words about 5 minutes/channel. It is to be understood that the time estimates for the present example are hypothetical. The actual times for embodiments of the present invention may be higher or lower than the estimated times of the present example.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A method of aligning an optical lens of an optical signal controller, the method comprising the steps of:
a) directing a collimated light beam toward a surface of the lens wherein the surface of the lens has a predetermined optical reflectivity;
b) measuring the amount of the light reflected by the lens;
c) moving the position of the surface of the lens with respect to the light of the beam until the amount of light reflected by the lens substantially equals a predetermined amount;
d) bonding the lens to the optical signal controller so as to maintain the amount of measured reflected light.

2. The method of claim 1 further comprising, before step a, the step of gripping the lens with a lens gripping fixture that includes a gripper holder for optical alignment.

3. The method of claim 2 further comprising, after step d, the step of removing the lens gripper from the aligned lens.

4. The method of claim 1 wherein the lens comprises a gradient refractive index lens.

5. The method of claim 1 wherein the optical signal controller comprises an optical switch.

6. The method of claim 5 wherein the optical switch includes n output channels with n being an integer.

7. The method of claim 6 further comprising repeating steps a through d for each channel.

8. The method of claim 1 wherein the optical signal controller comprises at least one of an optical switch, a variable optical attenuator, an opto-electronic switch, a power monitor, a fiber collimator, an optical isolator, and an optical circulator.

9. The method of claim 1 wherein the optical signal controller uses rotary motion of an optical component for optical signal control.

10. An optical signal controller having at least one output gradient refractive index lens and an optical component for directing an optical signal toward the lens, the optical component and the lens being optically aligned using the method of claim 1.

11. A method of aligning a gradient refractor index lens of a rotary motion optical switch having n output channels, the lens having a reflective surface with a predetermined optical reflectivity, the switch having a base, a dual fiber input collimator including an input signal fiber and a reflected signal fiber, the collimator being rotatably connected with the base, the base having a surface for attaching the lens, the method comprising the steps of:
a) directing a laser beam toward the lens reflective surface using the input fiber and the collimator, the lens being disposed proximate to an output channel of the switch;
b) measuring reflected light from the lens reflective surface via the collimator and reflected signal fiber;
c) moving the position of the lens reflective surface with respect to the light of the laser beam until the amount of light reflected by the lens reflective surface substantially equals a predetermined amount;
d) bonding the lens to the optical signal controller so as to maintain the amount of measured reflected light.

12. The method of claim 11 wherein the switch comprises a plurality of channels and further comprising the steps of:
rotating at least one of the collimator and the base so as to direct the laser beam toward a second channel and a second lens; and
repeating steps b through d for the second channel and a second lens.

13. The method of claim 11 wherein the switch comprises a plurality of channels and further comprising the steps of:
e) rotating at least one of the collimator and the base so as to direct the laser beam toward another channel and another lens; and
f) repeating steps b through d for the second channel and another lens.

14. The method of claim 13 further comprising the step of repeating steps e and f until a lens is bonded to each channel of the switch.

15. The method of claim 11 wherein step c comprises at least one of pitch motion, yaw motion, and pitch motion and yaw motion.

16. The method of claim 11 wherein step d comprises bonding using at least one of ultraviolet light cured epoxy, heat cured epoxy, low-temperature soldering, laser welding, and combinations thereof.

17. The method of claim 11 wherein step d comprises bonding using ultraviolet light cured epoxy.

18. The method of claim 11 wherein step c comprises using a micro-motion actuator for producing small changes in the position and orientation of the lens with respect to the laser beam.

19. The method of claim 11 wherein step c comprises producing at least one of pitch motion, yaw motion, and pitch motion and yaw motion of the lens with respect to the laser beam.

20. The method of claim 11 further comprising the step of recording the reflected light measurements as a function of the movement of the lens.

21. The method of claim 11 further comprising providing an amount of un-cured epoxy contacting the lens and the surface for attaching the lens.

22. The method of claim 21 wherein the uncured epoxy is present during step c.

23. An optical signal controller having at least one output gradient refractive index lens and an optical component for directing an optical signal toward the lens, the optical component and the lens being optically aligned using the method of claim 11.

24. The optical signal controller of claim 23 further comprising a bar code wherein the bar code indicia corresponds to a set of measurements of reflected signal and position of the collimator.

25. A station for aligning a gradient refractive index lens for an optical signal controller, the lens having a semi reflective surface, the station comprising:
a laser light source capable of providing an optical signal to the signal controller;
a detector for measuring reflected light intensity from a semi reflective surface of the lens;
a lens motion actuator, the actuator being capable of holding the lens, the actuator being capable of moving the lens so as to change the position or orientation of the lens;
a stage for holding the optical signal controller, the stage being capable of rotating the signal controller;
a lens bonder for bonding the lens to the signal controller;
a station controller, the station controller being connected with the detector to receive data measured by the detector, the controller being connected with the motion actuator so as to be capable of moving the lens in response to measurements from the detector, the station controller being connected with the bonder so as to be capable of initiating and terminating bonding of the lens to the signal controller has needed, the station controller being connected with the stage so as to be capable of controlling the rotary motion of the stage.

26. The station of claim 25 further comprising a lens gripper, the lens gripper being coupled to the actuator for holding the lens and moving the lens whereby movement of the lens occurs via the actuator moving the lens gripper.

27. The station of claim 25 wherein the station controller is capable of controlling the movement of the lens so as to substantially obtain a predetermined reflected signal measurement.

28. The station of claim 27 wherein the station controller comprises a feedback control loop for controlling the movement of the lens in response to the measured reflected light intensity.

29. The station of claim 25 wherein the bonder comprises at least one of an ultraviolet light source for curing epoxy, a heat source for curing epoxy, a laser for laser welding, and a heat source for heating solder.

30. The station of claim 25 wherein the bonder comprises an ultraviolet light source for curing epoxy.

31. The station of claim 27 wherein the station controller is capable of storing measurements of the amount of light reflected by the lens as a function of the movement of the lens.

32. An optical signal controller having at least one output lens aligned using the station of claim 25.

33. Computer readable media comprising executable instructions for performing the steps of:
a) placing a lens proximate to a first output channel position of an optical signal controller;
b) controlling the movement of the lens with respect to a laser beam directed toward the lens so as to achieve a measured amount of reflected light from the lens that substantially equals to a predetermined amount of light;
c) activating a bonding process so as to bond the lens to the signal controller when the measured amount of reflected light equals a predetermined amount of light;
d) repeating steps a through c for each channel of the optical signal controller.

34. The invention of claim 33 further comprising instructions for recording measurements of the amount of light reflected by the lens as a function of the movement of the lens.

35. The invention of claim 33 wherein step d comprises instructions for at least one of rotating the direction of the laser beam and rotating the optical signal controller.
